(19) United States
(12) Patent Application Publication
(10) Pub. No.: US 2019/0303909 A1
(43) Pub. Date: Oct. 3, 2019

(54) IMAGE SCANNER THAT TRANSMITS PAYMENT CREDENTIALS AS MAGNETIC STRIPE FORMATTED DATA TO A POINT OF SALE SYSTEM

(71) Applicant: FLUX QR SAPI DE CV, Mexico City (MX)

(72) Inventor: Fernando De la Torre, Mexico City (MX)

(21) Appl. No.: 16/359,592

(22) Filed: Mar. 20, 2019

Related U.S. Application Data
(60) Provisional application No. 62/651,113, filed on Mar. 31, 2018.

(51) Int. Cl. G06Q 20/32; G06K 7/14; G06K 7/10; G06Q 20/20; G06Q 20/38

(52) U.S. Cl. CPC G06Q 20/327; G06K 7/1417; G06K 7/10722; G06Q 2220/00; G06Q 20/385; G06Q 20/3829; G06Q 20/204

(57) ABSTRACT

An authorization system comprises a point-of-sale terminal (POS) having a magnetic stripe reader. An image scanner is located in proximity to the magnetic stripe reader of the POS terminal. The image scanner is a self-contained unit comprises an image sensor to capture an image of a matrix code having coded payment credentials unique for a particular payment transaction, wherein the matrix code is displayed on any of: a display of a mobile device, a display of a wearable device, a printed code, or a printed gift or loyalty card. A processor decodes the coded payment credentials, and formats the decoded payment credentials into magnetic stripe formatted data according to international standards. An antenna wirelessly transmits the magnetic stripe formatted data via magnetic pulses to the magnetic stripe reader of the POS terminal.

### CROSS-REFERENCE TO RELATED APPLICATIONS

This application claims the benefit of provisional Patent Application Ser. No. 62/651,113, filed Mar. 31, 2018, assigned to the assignee of the present application, and incorporated herein by reference.

### BACKGROUND

There are several approaches for adding contactless payment technologies to existing point-of-sale systems or payment terminals (collectively POS), most of which involve some modification or replacement of current POS infrastructure. A common contactless payment today is the user of near field communication (NFC), which is typically included in newer mobile phones. However, adding NFC to existing POS systems involves the modification of current POS software or the entire replacement of POS terminal to allow NFC payments. Moreover, if owners of payment cards do not have a compatible mobile phone, then the owners must purchase a new phone, or card issuers have to replace and distribute new cards to these owners.

Another approach is to connect image scanners, such as barcode readers, to POS terminals to communicate sales payment information. However, the image scanners are typically connected to the POS terminals with a wired plug in connection using serial ports, for example. A problem with this technique is that it requires modification to the POS software, which can be a complex and costly process, often requiring down time of systems and complex certification processes. Due to these complexities, merchants oftentimes consider instead technology replacements for legacy POS systems, resulting in considerable upgrading expenses.

Yet another approach is to equip a card owner's mobile device with a magnetic stripe transmission (MST) device to send payment information to a POS terminal using magnetic fields. Although this solution requires no wired connection to the POS, the solution requires the purchaser to use a mobile device and additional hardware connected to a port of the mobile phone to transmit the information. See for example, U.S. Pat. Nos. 9,454,679B2 or 8,628,012B1. The problem with this solution is that only specific models of mobile devices with specific hardware can make these transactions, or in a best-case scenario, the owner of the mobile phone has to buy additional hardware, limiting interoperability of transactions.

The compounded situations described above hinder the adoption of digital payments in a three-fold problem: I) the POS owner has to make a large investment to implement new technology at the POS device to start accepting digital payments; II) the card issuers have to distribute new physical cards or hardware to the final users and increasing implementation cost and deploy time; and III) users need to have specific hardware, either enabled cards or mobile devices or other peripheral device, instead of using their current devices.

Accordingly, it would be desirable to provide an improved contactless payment solution that does not incur any of the disadvantages of current solutions.

### BRIEF SUMMARY

The exemplary embodiment provides methods and systems for an authorization system that includes a point-of-sale terminal (POS) having a magnetic stripe reader. Aspects of exemplary embodiment include an image scanner located in proximity to the magnetic stripe reader of the POS terminal. The image scanner is a self-contained unit including an image sensor to capture an image of a matrix code having coded payment credentials unique for a particular payment transaction, wherein the matrix code is displayed on any of: a display of a mobile device, a display of a wearable device, a printed code, or a printed gift or loyalty card. A processor decodes the coded payment credentials, and formats the decoded payment credentials into magnetic stripe formatted data according to international standards. An antenna wirelessly transmits the magnetic stripe formatted data via magnetic pulses to the magnetic stripe reader of the POS terminal, wherein the payment transaction is further processed and completed without any software modifications required on the POS or any electrical hardware connections between the image scanner and the POS terminal.

According to the method and system disclosed herein, the self-contained image scanner provides a wireless and contactless payment solution that dispenses with the need for user/customers to invest in any new hardware, for card issuers to issue any new cards, and/or for merchants to invest in modifications to the POS terminal software.

### BRIEF DESCRIPTION OF SEVERAL VIEWS OF THE DRAWINGS

FIG. 1 illustrates an authorization system that utilizes an image scanner to transmit payment credentials as magnetic stripe formatted data to a point-of-sale (POS) to according to one embodiment.

FIGS. 2A and 2B illustrates examples of the positioning of the image scanner relative to the POS terminal.

FIG. 3 graphically illustrates how the antenna transmits binary data to the POS terminal.

FIG. 4 is an exploded view of the image scanner showing components and configuration thereof.

FIG. 5 is a flow diagram illustrating the enrollment process for the matrix payment service according to one example embodiment.

FIG. 6 is a flow diagram illustrating the matrix code generation process for the matrix payment service according to one example embodiment.

FIG. 7 illustrates one example of the contents of the Track 2 magnetic stripe formatted data.

FIG. 8 is a flow diagram illustrating payment transaction processing for the matrix code payment service using the matrix code according to one example embodiment.

### DETAILED DESCRIPTION

The exemplary embodiment relates to an image scanner that transmits payment credentials as magnetic stripe formatted data to a point of sale system. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide an image scanner that transmits payment credentials as magnetic stripe formatted data to a POS terminal. The image scanner is implemented as a self-contained unit that is placed in proximity to magnetic stripe reader of the POS terminal. During a purchase transaction, the image scanner scans a matrix code of coded payment credentials that may be displayed on a variety of different types of objects, and transmits the payment credentials as magnetic stripe formatted data via magnetic pulses to the magnetic stripe reader of the to the POS for completion of the transaction.

According to the image scanner of the present embodiments, the self-contained image scanner provides a wireless and contactless payment solution that alleviates the need for: i) user/customers to invest in any new hardware (e.g., phones or add-on hardware), ii) card issuers to issue any new cards and iii) merchants or payment services companies to invest in modifications or substitutions to the POS terminal software. Accordingly, the image scanner is a plug-and-play device that can facilitate mass adoption of digital payments by scanning payment credentials from any device capable displaying a coded image, such as a matrix code, and presenting the payment credentials to a POS terminal as magnetic stripe formatted data, which is then processed using current POS infrastructure. In one embodiment, the user's payment credentials in the form of a matrix code may be scanned from not only a display of an electronic device, but also from a printed code or a printed gift card.

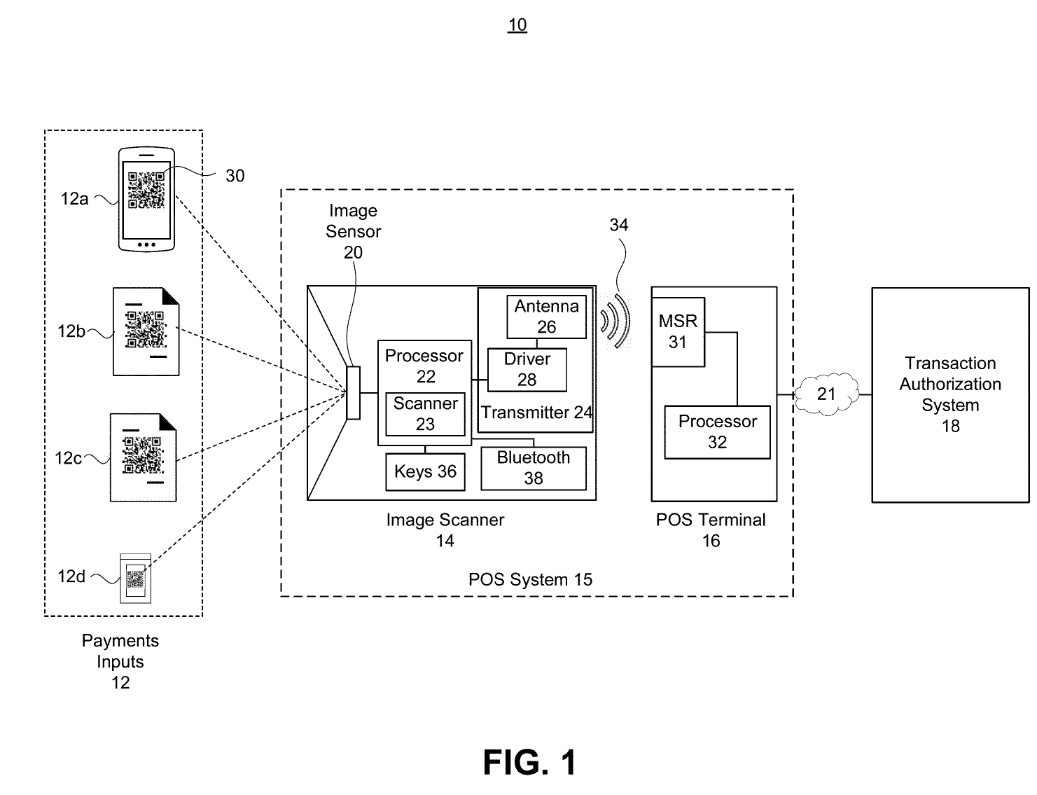

FIG. 1 illustrates an authorization system that utilizes an image scanner to transmit payment credentials as magnetic stripe formatted data to a POS terminal according to one embodiment. The authorization system 10 comprises an image scanner 14 that is an add-on device to a merchant POS terminal 16, whether a stand-alone payment terminal or a payment terminal integrated to a POS system 15, to facilitate contactless payment transactions with the existing POS terminal 16, which includes a magnetic stripe reader 31 and a processor 32.

In one embodiment, the image scanner 14 is a self-contained unit comprising an image sensor 20, a processor 22 that executes scanner software 23, and a transmitter 24 having an antenna 26 and a corresponding antenna driver 28. Prior to any sales transactions, the image scanner 14 is located in proximity to a magnetic stripe reader 31 of the POS terminal 16. When a payment transaction is initiated, a matrix code 30 (linear or 2D), such as a barcode or QR code, is presented to the image scanner 14 through any of a variety of different payment inputs 12.

The image sensor 20 captures an image of the matrix code 30 having coded payment credentials unique for the particular payment transaction. According to one aspect of the disclosed embodiments, the matrix code 30 is displayed on any of a variety of different payment inputs 12 in either digital or printed form, including a display of a mobile device 12a, a printed code 12b, a printed gift card 12c, and a display of a wearable device (e.g., a smartwatch).

The image of the matrix code 30 captured by the image scanner 14 is then decoded by the processor 22 via the scanner software 23 to obtain the coded payment credentials. The processor 22 then formats the decoded payment credentials into magnetic stripe formatted data according to international standards. The processor 22 instructs the antenna driver 28 to wirelessly transmit the magnetic stripe formatted data over the antenna 26 via magnetic pulses 34 to the magnetic stripe reader 31 of the POS terminal 16. The processor 32 of the POS terminal 16 sends the payment credentials over a network 21 (e.g., Internet) to the transaction processing network 18, where the payment transaction is further processed and completed. According to the disclosed embodiments this is accomplished without any software modifications required on the POS terminal 16 or any electrical hardware connections between the image scanner 14 and the POS terminal 16.

In one embodiment, the content of the magnetic stripe formatted data containing the payment credentials of the transaction can be controlled by the matrix code 30 presented to the image scanner 14. According to one embodiment, the payment credentials in the matrix code 30 contain dynamic information corresponding to a single user and single payment transaction that can be authenticated by the transaction authorization system 18, an issuer of user identification credentials, and/or a matrix code service provider. In one embodiment, the unique payment credentials in the matrix code 30 comprises a one-time password (OTP) token (or pin). Consequently, use matrix code 30 and the image scanner 14 increases the security of magnetic stripe payments. Since the one-time-use payment credentials resides in payment inputs 12, a card issuer can implement improved security over the use of static magnetic stripe cards that merely contain static payment information about a user, but not about a specific payment transaction.

In one embodiment, the image scanner 14 can have stored a set of keys 36 for use by the processor 22 to decode any encryped portions of the payment credentials for additional security depending on the application. The keys 36 may include a cryptographic controller and key manager (not shown) for public and private key schemes or any other configuration.

Additionally, the image scanner 14 can contain a Bluetooth device 38 for purposes such as user authentication and/or alerting a customer that services provided by the image scanner 14 are available, which may be displayed on smart devices, and other applications, including initiating a payment, such as on a screen of the mobile device 12a or the wearable device 12d. For example, a Bluetooth beacon can be transmitted to signal customers having Bluetooth enabled smart devices that the contactless payment method is available as customers approach the POS system 15 and/or POS terminal 16. This Bluetooth beacon signal can also trigger a specific behavior on the smart device, such as prompting customers to use a preferred payment method.

In one particular smart device use case, issuers may transmit digital cards (credit, debit, coupons, loyalty cards, gift cards and other) to smart devices, such as smartphones or wearable devices, mostly agnostic to brand, model and operating system. The digital cards can be then used at legacy POS systems 15 for use in the authorization system 10 without the need to modify current infrastructure at the POS system 15 and the transaction authorization system 18 (at least for completing payment transactions).

Although the image scanner 14 has been described for use in a payment authorization system, the image scanner 14 and its features can be used for any purpose or type of authorization systems where a magnetic stripe infrastructure is present. For example, the image scanner may be used to authenticate user credentials in systems that incorporate magnetic stripe readers for user identification, such as for example, door lock and employee access systems, or other similar systems, without the need to issue physical magnetic stripe cards. In this embodiment, the magnetic stripe reader may include a processor and communication interfaces for communicating with a backend authorization system containing user access rights. The matrix code may be displayed on a smart device of the user or printed on a physical security badge. Once received, the authorization system completes the authorization based on a comparison of the user credentials to user the access rights, or more specifically, based on a query with the user credentials of user's rights. No modifications to the software of the magnetic stripe reader are required nor are any electrical hardware connections between the image scanner and the magnetic stripe reader.

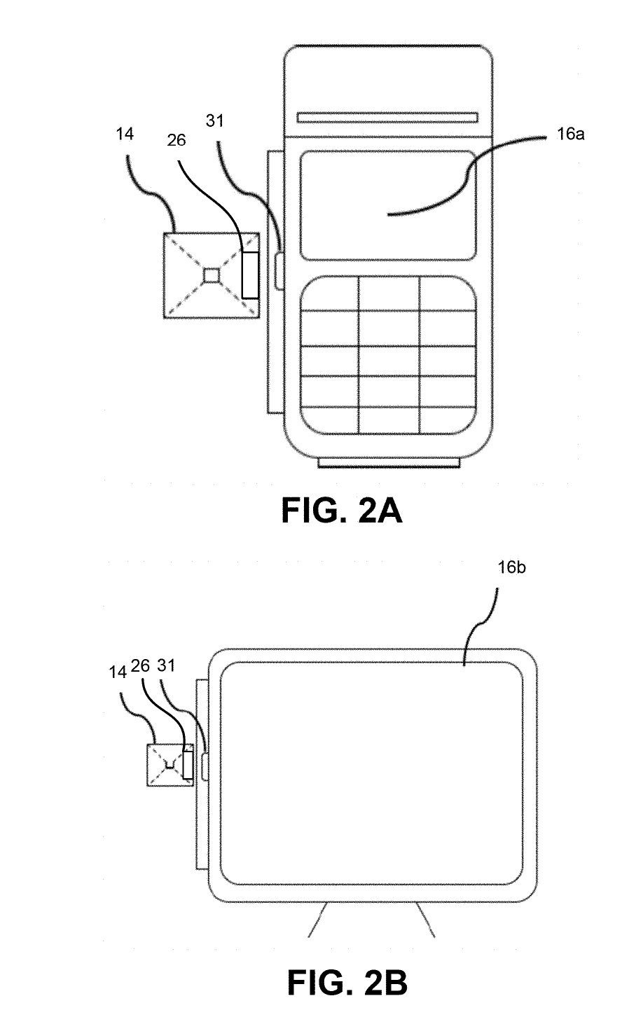

FIGS. 2A and 2B illustrates examples of the positioning of the image scanner relative to the POS terminal. Referring to FIG. 2, a mobile or countertop POS terminal 16a is shown, which is typically located on a checkout counter or attached to a merchant's mobile phone. The POS terminal 16a includes a magnetic stripe reader 31 located along a side of the POS terminal 16a. In one embodiment, the image scanner 14 houses all components of the image scanner 14 including the antenna 26. The antenna 26 of the image scanner 14 is responsible for delivering magnetic pulses 34 to a magnetic head of the magnetic stripe reader 31 on the POS terminal 16a and can be attached adjacently to, or at least placed in close proximity of, the magnetic stripe reader 31 to reduce the energy required for such pulses.

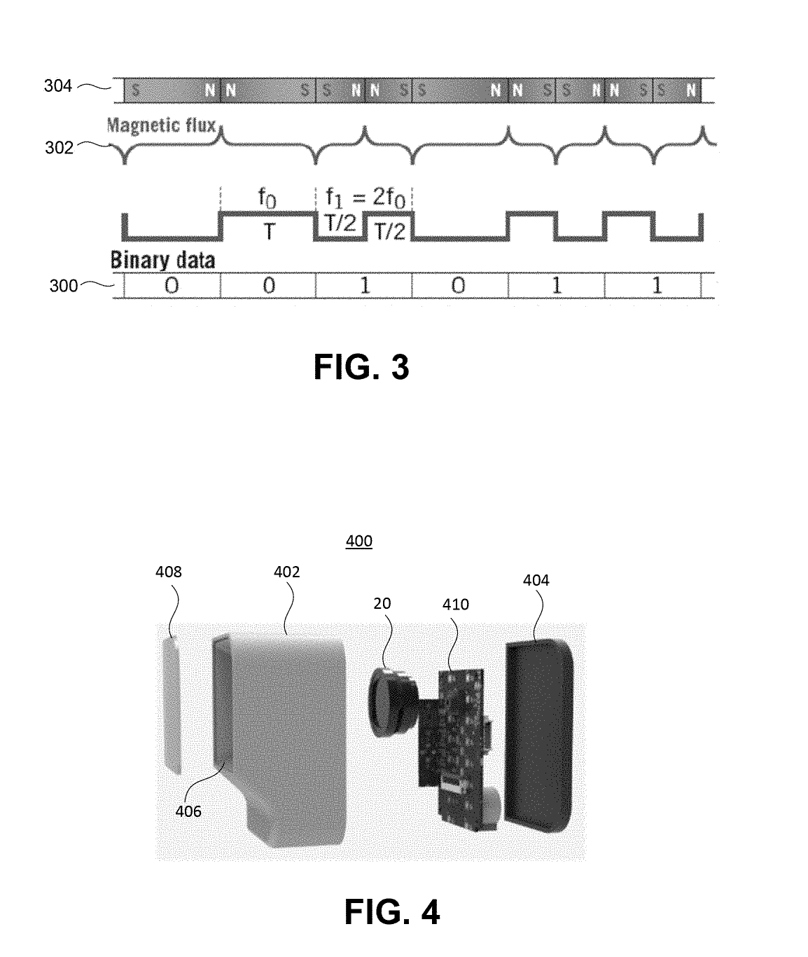

FIG. 2B shows an example of a traditional retail POS terminal 16b having components of a desktop computer or tablet. In this example, the magnetic stripe reader 31 is along side of a monitor of the POS terminal 16b, and the image scanner 14 is attached to the other side of the magnetic stripe reader 31. In an alternative embodiment to FIGS. 2 and 3, the antenna 26 of the image scanner 14 can be independent from the main casing of the image scanner 14, but attached to the magnetic stripe reader 31, if the image scanner 14 must be located farther away from POS terminal 16a or 16b.

In one embodiment, an antenna 26 may be implemented as a Tesla bifilar flat coil to create a greater magnetic field without the use of more energy. As is well known a Tesla by bifilar flat coil is an electromagnetic coil that contains two closely spaced, parallel windings, that are connected in series. Also a ferrite bead can be added on one side of the antenna to limit the magnetic field spreading into undesired directions. Whether attached physically or not, in one embodiment, the antenna 26 should be placed within approximately two centimeters from the magnetic stripe reader 31 of the POS terminal 16a. Although the antenna 26 is adjacent to the POS terminal 16a, use of the antenna 26 does not interfere (mechanically or digitally) with other magnetic stripe card operations.

FIG. 3 graphically illustrates how the antenna 26 transmits binary data 300 to the POS terminal 16. In one embodiment, the antenna 26 sends binary 0s and 1s to the magnetic stripe reader 31 using magnetic field fluctuations 302. The antenna 26 may emulate a north-south magnetic field 304 and then reverse the magnetic field continuously over time. To send a 1 to the magnetic stripe reader 31, the magnetic field must change twice in the same time lapse as a zero, as shown.

FIG. 4 is an exploded view of the image scanner showing components and configuration thereof. As shown, in embodiments the image scanner 400 is a single, self-contained unit comprising a main casing 402 and a back casing 404 that together house the image sensor 20 and a main board 410. In one embodiment the image sensor 20 comprises a wide angle lens and is aligned with a cone-shaped opening 406 in the main casing 402. A protective glass 408 may cover the cone-shaped opening 406. The cone-shaped opening 406 manages reflection, protects the image sensor 20 and increases reader speed. The cone-shaped opening 406 also acts as a cue to indicate to customers where to hold the various payment inputs 12 (FIG. 1) for scanning. The main board 410 provides interconnections between the processor 22, transmitter 24 and Bluetooth device 38 (FIG. 1), as well as memory that stores programs and keys 36 (FIG. 1). To improve the readability of the input, the image scanner 400 may also include an illumination source and/or a speaker (not shown).

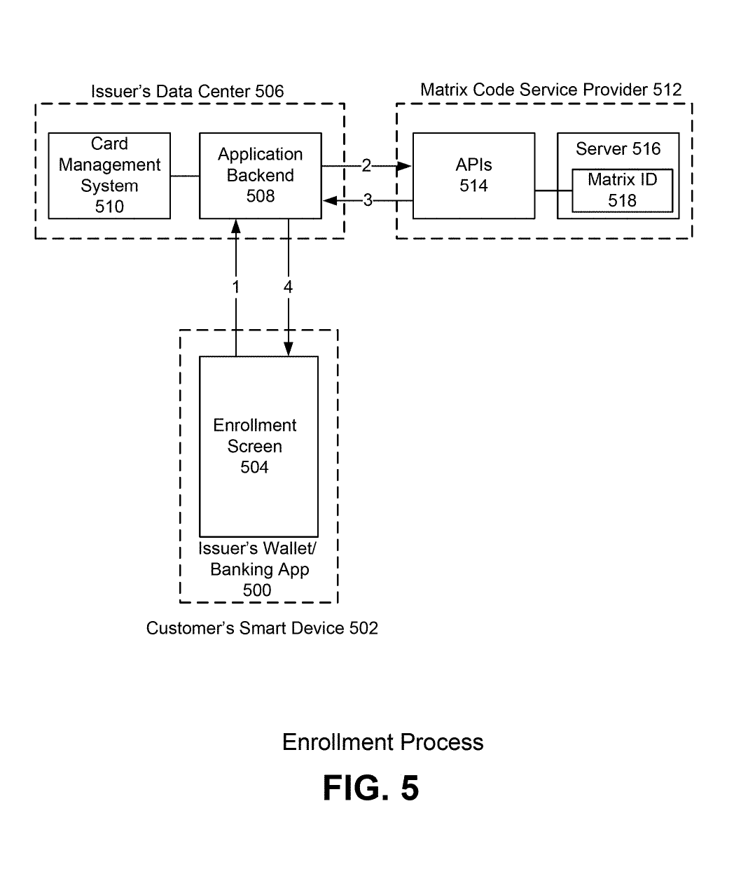

FIG. 5 is a flow diagram illustrating the enrollment process for the matrix payment service according to one example embodiment. Prior to a customer using the matrix payment service with a credit card issued by a credit card issuer, the customer must first download and install a wallet/banking application 500 on the customer's smart device 502. When the wallet/banking application 500 is started the first time, the wallet/banking application 500 displays an enrollment screen 504.

The enrollment process may begin by the issuer's wallet/banking application 500 sending customer enrollment information to the issuer's data center 506 (step 1). In one embodiment, the issuer's data center 506 may include an application backend 508 and a card management system 510. In one embodiment, the enrollment information may include a customer ID, payment credentials, phone manufacturer, phone number, operating system version, geolocation, or more related information, which together may form a “device fingerprint”.

The issuer's application backend 508 and/or the card management system 510 validates the information and forwards it to the matrix code service provider 512. In one embodiment, the information is sent (step 2) to the server 516 of the matrix code service provider 512 through an application programming interface (API) 514, which registers the customer's smart device 502. A server 516 of the matrix code service provider 512 then generates a matrix code ID 518 and stores in association with the matrix code ID 518 the device fingerprint, including the customers payment credentials.

The matrix code service provider 512 returns the matrix code ID 518 to the application backend 508 of the issuer's data center 506 (step 3). In one embodiment, the issuer's data center 506 may optionally register the matrix code ID in issuer's systems if required. This issuer's data center 506 then forwards the matrix code ID to the issuer's wallet/banking application 500, where the matrix code ID is securely stored (step 4).

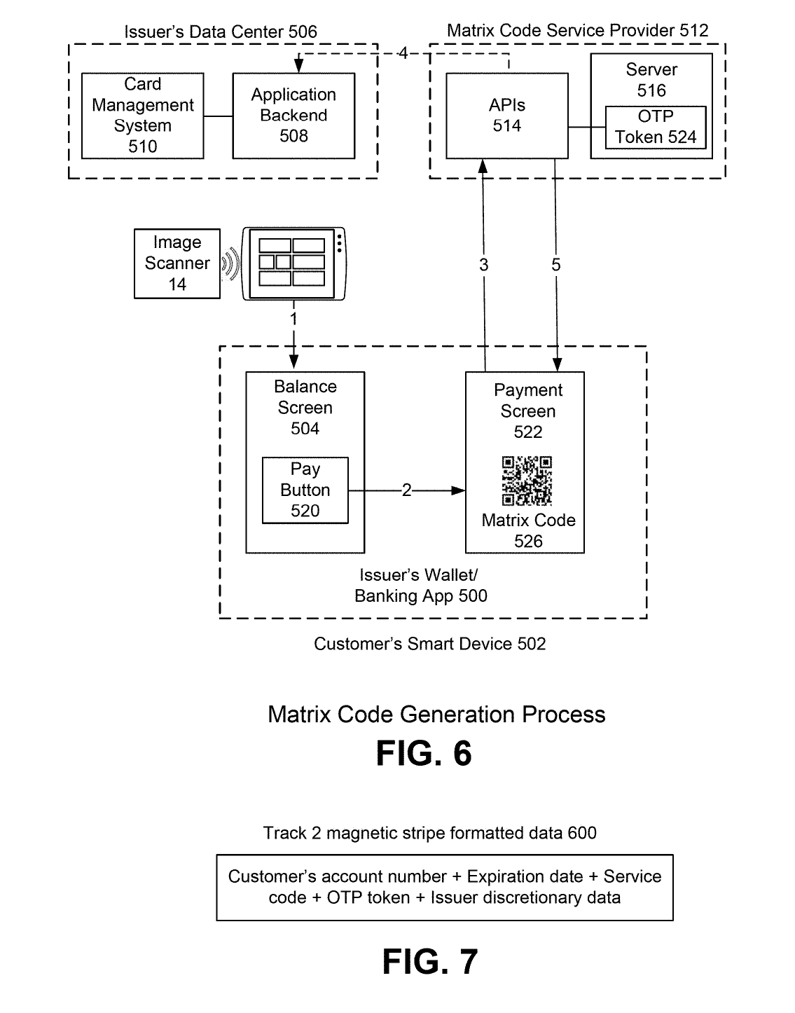

FIG. 6 is a flow diagram illustrating the matrix code generation process for the matrix code payment service according to one example embodiment. The matrix code generation process is initiated by the POS terminal 16 during a new payment transaction when a sales amount is entered and the issuer's wallet/banking application 500 is notified of the new payment transaction (step 1). In one embodiment, the issuer's wallet/banking application 500 is notified of the new payment transaction either through wireless communication (e.g., Bluetooth) from the POS terminal 16 or through notification from the issuer's data center 506. Assuming the matrix code ID 518 is present on the customer's smart device 502, when the issuer's wallet/banking application 500 receives the notification of a new payment transaction, the issuer's wall/banking application 500 displays a balance screen 504 with a pay button 520 and optionally the balance or sales amount.

In response to the issuer's wallet/banking application 500 detecting that the pay button 520 has been pressed, the issuer's wallet/banking application 500 displays a payment screen 522 (step 2). The issuer's wallet/banking application 500 also sends a request for a one-time password (OTP) token 524 to the matrix code service provider 512 (step 3). In one embodiment, the OTP token 524 is unique for each payment transaction and the use of the OTP token 524 hardens transaction security by adding another, dynamic credential. In one embodiment, the request also includes the customer's matrix code ID 518 and the device fingerprint of the customer smart device 502 to validate the request. In one embodiment the device fingerprint may identify the phone manufacturer, phone number, operating system version, geolocation, and/or other related information. In some embodiments, the device fingerprint also includes the customers payment credentials.

Responsive to receiving the request, the server 516 validates the user using the matrix code ID 518 and the device fingerprint, and generates the OTP token 524. The server 516 also formats the customer's payment credentials into Track 2 magnetic stripe formatted data, and adds the OTP token 524 to add a dynamic, one-time password to the Track 2 magnetic stripe formatted data. In another embodiment, the wallet/banking application 500 may format the data as magnetic stripe formatted data.

FIG. 7 illustrates one example of the contents of the Track 2 magnetic stripe formatted data. In one embodiment, the Track 2 magnetic stripe formatted data 600 may include the customer's account number, expiration date, service code, the OTP token 524 and issuer discretionary data. In one embodiment, the matrix code service provider 512 may encrypt the OTP token 524 and/or format the OTP token 524 in any other way, for example, coded as based 64 or TLV format (TLV=tag, length, value). The issuer discretionary data may contain additional dynamic data. According to the disclosed embodiments, during a payment transaction, the OTP token 524, and possibly other dynamic data, travels transparently within current magnetic stripe infrastructure all the way to the issuer to validate the OTP token and authorize the payment transaction.

Referring again to FIG. 6, according to one aspect of the disclosed embodiments, there two options for storing the OTP token 524 for subsequent validation during a payment transaction. In a first embodiment, the server 516 can notify the card management system 510 of the issuer's data center 506 (through the application backend 508) of the newly created OTP token 524 (step 4). In this embodiment, the OTP token 524 can then be authorized by the issuer when a payment transaction is received. In a second embodiment, the issuer's card management system 510 can send a request to the matrix code service provider 512 for authorization of a specific OTP token when a payment transaction is received.

After the matrix code service provider 512 generates and adds the OTP token 524 to the Track 2 magnetic stripe formatted data 600, the Track 2 magnetic stripe formatted data 600 is returned to the issuer's wallet/banking application 500 and displayed as a matrix code 526 on the payment screen 522 (step 5). The information sent is (or contains) a string of Track2 data. The smart device 502 transforms this string of data into the matrix code 526. The customer then presents the matrix code 526 to the image scanner 14 to perform the payment transaction.

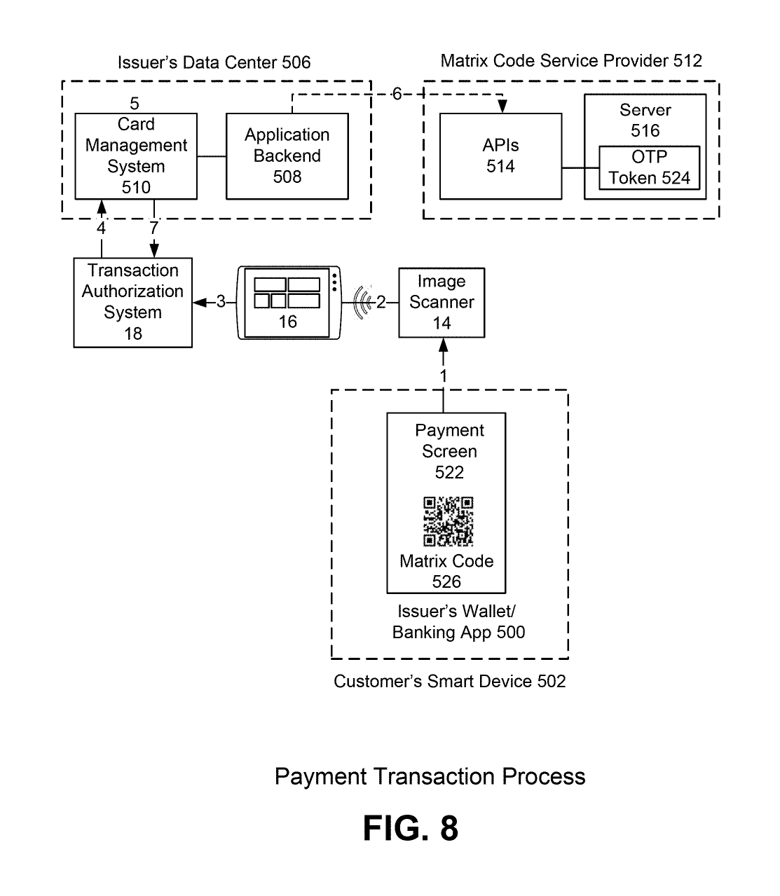

FIG. 8 is a flow diagram illustrating payment transaction processing for the matrix code payment service using the matrix code according to one example embodiment. Payment transaction processing may begin after the customer presents the matrix code 526 to the image scanner 14 in response to the POS terminal 16 requiring a payment card to swiped, dipped, or tapped (step 1). The image scanner 14 captures an image of the matrix code 526, decodes payment credentials in the matrix code 526, decrypts the payment credentials with the internal cryptographic keys 36 (FIG. 1) if the encrypted, formats the payment credentials into Track 2 magnetic stripe formatted data, and wirelessly transmits the Track 2 magnetic stripe formatted data to the POS terminal 16 via magnetic pulses (step 2).

The POS terminal 16 interprets receipt of the magnetic pulses as a card having been swiped and continues with payment process by assembling payment credentials from the Track 2 magnetic stripe formatted data 600 according to magnetic stripe data standards and sends the payment credentials to the transaction authorization system 18 (step 3). The transaction authorization system 18, which may comprise one or more transaction processors, routes the standard magnetic stripe data to the issuer's data center 506 (step 4). The magnetic stripe data may be routed according to a conventional magnetic stripe transaction flow, using the same standards, with the difference that the magnetic stripe data includes unique information, such as in some embodiments the OTP token 524 corresponding to the current payment transaction.

The card management system 510 receives the magnetic stripe data and may identify the payment transaction based on a BIN number (e.g., first 6 digits of a card) to apply specific authorization procedures (step 5). This is done commonly with payment cards, to differentiate credit from debit cards, or to apply different kind of transaction analytics or fraud-prevention rules.

Next, the issuer's data center 506 validates the OTP Token 524 (step 6). Corresponding to step 4 from the matrix generation process, there are two embodiments for validating the OTP token 524. In a first embodiment, the issuer's card management system 510 checks a list of available OTP tokens 524 provided by the matrix service provider 512 and attempts to match a specific OTP token 524 from the incoming payment transaction. In a second embodiment, the issuer's card management system 510 may send a request to the matrix service provider 512 for authorization of a specific OTP token 524 from the incoming payment transaction. Once the OTP token 524 has been validated, the issuer continues with the traditional authorization process that may include balance debit on the account and to accept or decline the transaction.

Although the present embodiments have been described in terms of the image scanner wirelessly communicating with the POS terminal 16, in an alternative embodiment, the image scanner may communicate with the POS terminal 16 through a wired connection, such as USB.

In one embodiment, instead of providing matrix code service provider APIs 514 and server 516 externally of the issuer's data center 506, the matrix code service provider 512, may provide a hardware and/or software component located inside the Issuer's data center 506, to validate tokens and run all processes. This may modify how step 6 is performed and result in obtaining payment information from a single server and API.

The issuer's data center 506 returns a confirmation of acceptance or disapproval of the payment transaction to the transaction authorization system 18 (step 7). The POS terminal 16 receives the confirmation and displays confirmation to the merchant.

In another embodiment, the OTP token 524 may be generated locally inside the issuer's/wallet banking application without connecting to a server. In one embodiment, this may be implemented by providing a “seed” during the enrollment process, which later is used to generate OTP tokens. Then, when a payment transaction flows into the issuer's server as a payment, the issuer system uses the same seed and time reference to validate the information.

In yet a further embodiment, inside the issuer's data center 506, enrollment and the OTP token generation can have a length of time on which they can be valid, similar to when a session expires on a website, requiring another login. The session expiration date may be used for additional security, which is referred as token life cycle.

A method and system for an image scanner that transmits payment credentials as magnetic stripe formatted data to a point of sale system has been disclosed. The present invention has been described in accordance with the embodiments shown, and there could be variations to the embodiments, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory. Accordingly, many modifications may be made by one of ordinary skill in the art without departing from the spirit and scope of the appended claims.

We claim:

1. An authorization system, comprising:
a point-of-sale terminal (POS) having a magnetic stripe reader;
an image scanner located in proximity to the magnetic stripe reader of the POS terminal, wherein the image scanner is a self-contained unit comprising:
an image sensor to capture an image of a matrix code having coded payment credentials unique for a particular payment transaction, wherein the matrix code is displayed on any of: a display of a mobile device, a display of a wearable device, a printed code, or a printed gift or loyalty card;
a processor to decode the coded payment credentials, and to format the decoded payment credentials into magnetic stripe formatted data according to international standards; and
an antenna to wirelessly transmit the magnetic stripe formatted data via magnetic pulses to the magnetic stripe reader of the POS terminal, wherein the particular payment transaction is further processed and completed without any software modifications required on the POS or any electrical hardware connections between the image scanner and the POS terminal.

2. The authorization system of claim 1, wherein the coded payment credentials include dynamic information corresponding to one user and one payment transaction.

3. The authorization system of claim 2, wherein the coded payment credentials include a one-time password (OTP) token.

4. The authorization system of claim 1, wherein processor executes scanner software to decode the coded payment credentials from the image of the matrix code.

5. The authorization system of claim 1, further comprising: a transmitter comprising the antenna and an antenna driver.

6. The authorization system of claim 1, further comprising: a set of keys stored in the image scanner to decode any encrypted portions of the coded payment credentials.

7. The authorization system of claim 6, further comprising: a cryptographic controller and a key manager.

8. The authorization system of claim 1, further comprising: a Bluetooth device to perform at least one of user authentication and alerting a customer that services provided by the image scanner are available.

9. The authorization system of claim 8, wherein the Bluetooth device transmits a Bluetooth Beacon to Bluetooth enabled smart devices to signal customers of at least one of: that a contactless payment method is available, or to trigger a specific behavior on the smart devices.

10. An image scanner in an authorization system, the image scanner, comprising:
a casing located in proximity to a magnetic stripe reader, the casing housing:
an image sensor to capture an image of a matrix code having coded payment credentials unique for a particular payment transaction, wherein the matrix code is displayed on any of: a display of a mobile device, a display of a wearable device, a printed code, or a printed gift or loyalty card;
a processor to decode the coded payment credentials, and to format the decoded payment credentials into magnetic stripe formatted data according to international standards; and
an antenna to wirelessly transmit the magnetic stripe formatted data via magnetic pulses to the magnetic stripe reader of the POS terminal, wherein the particular payment transaction is further processed and completed without any software modifications required on the POS terminal or any electrical hardware connections between the image scanner and the POS terminal.

11. The image scanner of claim 10, wherein the coded payment credentials include dynamic information corresponding to one user and one payment transaction.

12. The image scanner of claim 11, wherein the coded payment credentials include a one-time password (OTP) token.

13. The image scanner of claim 11, wherein processor executes scanner software to decode the coded payment credentials from the image of the matrix code.

14. The image scanner of claim 11, further comprising: a transmitter comprising the antenna and an antenna driver.

15. The image scanner of claim 11, further comprising: a set of keys stored in the image scanner to decode any encrypted portions of the coded payment credentials.

16. The image scanner of claim 15, further comprising: a cryptographic controller and a key manager.

17. A method for processing a payment transaction in a point-of-sale system (POS) having a magnetic stripe reader, the method comprising:
placing an image scanner in proximity to the magnetic stripe reader of the POS, wherein the image scanner is a self-contained unit comprising an image sensor, a processor, and an antenna;
capturing, by the image sensor, an image of a matrix code having coded payment credentials unique for a particular payment transaction, wherein the matrix code is displayed on any of: a display of a mobile device, a display of a wearable device, a printed code, or a printed gift or loyalty card;
decoding, by the processor, the coded payment credentials;
formatting, by the processor, the decoded payment credentials into magnetic stripe formatted data according to international standards;
wirelessly transmitting, by the antenna, the magnetic stripe formatted data via magnetic pulses to the magnetic stripe reader of the POS terminal, where the particular payment transaction is further processed and completed without any software modifications required on the POS terminal or any electrical hardware connections between the image scanner and the POS terminal.

18. The method of claim 17, further comprising: including in the coded payment credentials dynamic information corresponding to one user and one payment transaction.

19. The method of claim 18, further comprising: including in the coded payment credentials a one-time password (OTP) token.

20. The method of claim 21, further comprising: executing, by the processor, scanner software to decode the coded payment credentials from the image of the matrix code.

21. The method of claim 21, further comprising: including a transmitter comprising the antenna and an antenna driver.

22. The method of claim 21, further comprising: including a set of keys stored in the image scanner to decode any encrypted portions of the coded payment credentials.

23. The method of claim 22, further comprising: including a cryptographic controller and a key manager.

24. The method of claim 21, further comprising: performing, by a Bluetooth device, at least one of user authentication and alerting a customer that services provided by the image scanner are available.

25. The method of claim 24, further comprising: transmitting, by the Bluetooth device, a Bluetooth Beacon to Bluetooth enabled smart devices to signal customers of at least one of: that a contactless payment method is available, or to trigger a specific behavior on the smart devices.

26. An authorization system, comprising:
a magnetic stripe reader in communication with an authorization system containing user rights;
an image scanner located in proximity to the magnetic stripe reader, wherein the image scanner is a self-contained unit comprising:
an image sensor to capture an image of a matrix code having coded user credentials unique for user access, wherein the matrix code is displayed one of a smart device and a physical security badge;
a processor to decode the coded user credentials, and to format the decoded user credentials into magnetic stripe formatted data according to international standards; and
an antenna to wirelessly transmit the magnetic stripe formatted data via magnetic pulses to the magnetic stripe reader, wherein user authentication is further processed and completed by the authorization system based on a query with the user credentials of the user rights without any software modifications required on the magnetic stripe reader or any electrical hardware connections between the image scanner and the magnetic stripe reader.
